(19) United States
(12) Patent Application Publication
(10) Pub. No.: US 2009/0267009 A1
(43) Pub. Date: Oct. 29, 2009

(54) Device for damping the armature stroke in solenoid valves

(76) Inventors: Tilo Hofmann, Markgroeningen (DE); Claus Fleig, Asperg (DE)

Correspondence Address: KENYON & KENYON LLP, ONE BROADWAY, NEW YORK, NY, 10004, US

(21) Appl. No.: 11/921,619

(22) PCT Filed: May 22, 2006
(86) PCT No.: PCT/EP2006/062478

§ 371 Date: Jan. 8, 2009

(30) Foreign Application Priority Data
Jun. 30, 2005 (DE) 102005030957.7

(51) Int. Cl. F16K 31/06

(52) U.S. Cl. 251/129.15

(57) ABSTRACT

A solenoid valve for actuating an actuator having an armature and an electromagnet. The stroke of the armature is transferred to the actuator via a transfer element. The armature is accommodated in a guide of a housing of the solenoid valve. A damping element is situated between the armature and the transfer element, at least one aperture cross section being formed perpendicularly or coaxially to a symmetry axis in the damping element.

### FIELD OF THE INVENTION

The present invention relates to a device for damping the armature stroke in solenoid valves which are used as actuators in the automotive industry, for example.

### BACKGROUND INFORMATION

German Patent Application No. DE 196 50 865 A1 describes a solenoid valve. This solenoid valve is used for controlling an injector of a fuel injection device having a valve needle whose opening and closing is controlled by a solenoid valve. This solenoid valve has an electromagnet, an armature, and a valve member which is moved by the armature and acted upon in the closing direction by a valve spring. The valve member cooperates with a valve seat, the armature having a two-piece design with a first armature part which, relative to a second armature part, is displaceable under the effect of its inert mass in the closing direction of the valve member against the force of a restoring spring. A part of a hydraulic damping device is provided on the first armature part which makes it possible to dampen post-oscillation of the first armature part during its dynamic displacement. The first armature part is slidingly guided on a second armature part which is designed as an armature bolt and the other part of the damping device is accommodated on a fixedly located part of the solenoid valve. The fixedly located part of the solenoid valve is a sliding piece guiding the armature bolt.

German Patent Application No. DE 102 49 161.5 describes a device for setting the armature stroke of a solenoid valve.

The armature is actuated upon operation of the solenoid valve and includes a stop sleeve which is located in an axial guide with respect to a main body of the solenoid valve and is adjustable in the axial position with respect to the main body of the solenoid valve. This stop sleeve forms a stop for limiting the armature stroke in an axial direction, an adjustable setting element having two threaded sections of different thread leads and the same thread direction being provided. This setting element makes it possible to set the position of the stop sleeve, the first threaded section engaging in a corresponding first threaded section of the stop sleeve and the second threaded section engaging in a corresponding threaded section of the main body.

According to the approach described in German Patent Application No. DE 102 49 161, the armature stroke is set by the threaded sections on the stop sleeve and the main body. According to the approach described in German Patent Application No. DE 196 50 865 A1, the armature stroke is damped via a hydraulic damping device.

A solenoid valve having a damped one-piece armature element is described in German Patent Application No. DE 101 31 125 A1. The solenoid valve controls an injector of a fuel injection device which includes a needle/plunger system whose opening and closing are effected by pressurization/pressure relief of a control space, the solenoid valve including an electromagnet and an armature. A valve spring acts upon the armature in the closing direction on a valve seat which is opened or closed by a closing body which relieves the pressure in the control space. As described in German Patent Application No. DE 101 31 125 A1, the armature is designed as a one-piece component including an armature plate and an armature bolt, the bottom side of the armature plate being assigned to an element which dampens the downward movement of the armature into the valve seat.

In the above-described approaches, the armature is damped via hydraulically acting damping devices or via springs which are situated in an oil-filled interior space of the solenoid valve. It is additionally possible to damp an armature via hydraulic cross sections which are produced by a machining process and through which oil is displaced which generates a damping effect. Bore holes, which represent hydraulic cross sections, are applied eccentrically and therefore generate relatively high manufacturing costs. Since these bore holes are also applied to relatively thick-walled components to achieve hydraulic damping, the aperture function of these hydraulic cross sections is disadvantageous due to the unfavorably large length/diameter ratio.

### SUMMARY

An object of the present invention is to create a device for damping the armature stroke in solenoid valves which is producible very cost-effectively.

Following the approach described according to the present invention, a damping element is proposed, which may be cup-shaped and which may be directly pressed onto or into the armature or it may be mounted onto a shaft cooperating with the armature. The proposed damping element is characterized in that multiple functions are integrated into it. On the one hand, the damping action may be calibrated via the material selection and the geometry. In the preferably cup-shaped damping element, a coupler point, e.g., as a head-shaped elevation, is formed in a base surface. Due to the small thickness of the base of the cup-shaped damping element, a good aperture function may be implemented when apertures, e.g., in the form of bore holes, are introduced into this base which form aperture cross sections through which a fluid, such as oil, for example, is displaced. Due to the short length/diameter ratio on the damping element according to the present invention, the aperture function is settable in wide boundaries and easily and cost-effectively implementable.

In addition, the function of a spring receptacle may be integrated into the damping element according to the present invention, which may be carried out by forming an annular shoulder on the open side of the proposed damping element. A spring element may alternatively also be attached to the base surface of the damping element. Furthermore, the cup-shaped damping element according to the present invention provides the function of magnetic isolation of the armature of the solenoid valve from a valve needle to be operated.

The cup-shaped damping element according to the present invention may be manufactured very cost-effectively via punching or bending processes or also, when made of plastic, by way of injection molding. The damping element according to the present invention may be fastened directly on the armature or on a shaft cooperating with the armature via pressing-on, pressing-in, welding-on, or caulking.

The proposed damping element is characterized by a good aperture function in addition to its multiple functionality since there is a small length/diameter ratio with respect to the aperture cross sections introduced into the base and by the fact that small aperture diameters may easily be implemented. The aperture cross sections may also be implemented in the lateral surface of the cup-shaped or hat-shaped damping element. The aperture cross sections may be bore holes or slots through which the fluid, e.g., oil, contained in an interior space of a solenoid valve overflows, thereby generating the damping effect. The high manufacturing costs previously incurred by eccentrically introducing the aperture cross sections as longitudinal bore holes may be considerably lowered by using the damping element according to the present invention. In addition to magnetically isolating a valve needle from the armature of a solenoid valve, magnetically isolating a spring of a spring element from the armature of the solenoid valve is also possible. Finally it should be noted that the coupler point on the base of the damping element according to the present invention may be implemented very cost-effectively. Moreover, there is the possibility to form the coupler point between the armature and a valve needle or between the armature and a shaft cooperating with the armature by a head-shaped elevation in the base of the damping element according to the present invention or by a plane surface. Both design variants of the coupler point may be implemented on the damping element according to the present invention which represents a separate component.

### BRIEF DESCRIPTION OF THE DRAWINGS

The present invention is explained in greater detail based on the figures.

FIG. 1 shows a perspective view of the damping element according to an example embodiment of the present invention.

FIG. 2 shows a section through the damping element represented in FIG. 1 according to section II-II.

FIG. 3 shows a damping element according to the representation in FIG. 1 which is attached to an armature of a solenoid valve.

FIG. 4 shows a damping element pressed into an armature of a solenoid valve.

FIG. 5 shows a damping element according to the present invention having a spring element which rests on a support of the valve needle.

FIG. 6 shows a damping element according to the present invention which rests in a doubly supported armature of a solenoid valve.

### DETAILED DESCRIPTION OF EXAMPLE EMBODIMENTS

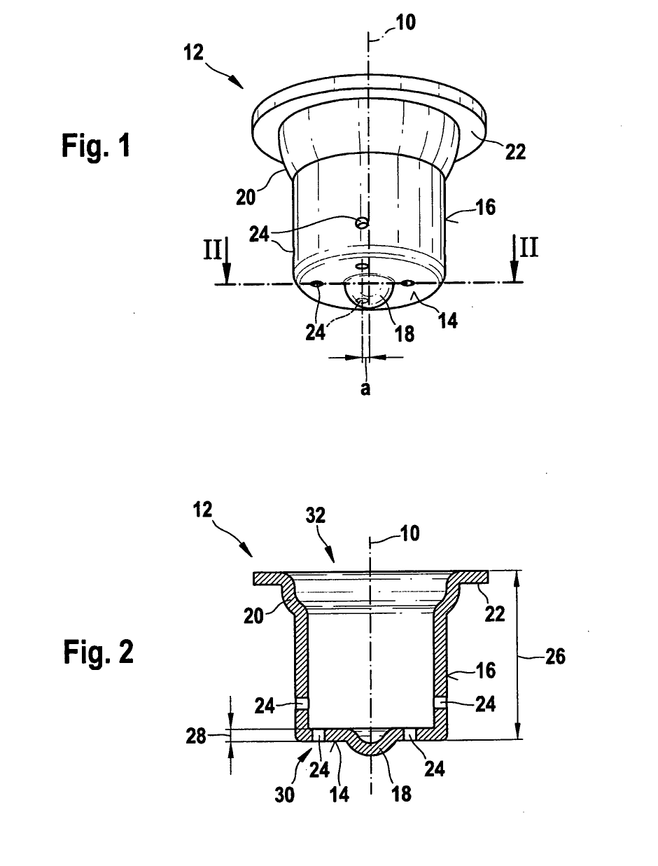

The damping element according to the present invention is shown in a perspective view in FIG. 1.

Damping element 12 has a generally cup-shaped geometry (see FIG. 2) and is built symmetrically with respect to a symmetry axis 10. Damping element 12 includes a base surface 14 and a lateral surface 16. Multiple aperture cross sections 24, which may be produced as bore holes, are provided in base surface 14 of damping element 12. Alternatively, aperture cross sections 24 for an overflowing fluid, such as oil for example, generating the damping may also be provided in lateral surface 16 or in base surface 14 and lateral surface 16 of damping element 12. Aperture cross sections 24 may have a circular, oval, slot-shaped, rectangular, square, or even kidney-shaped design or be designed in any other geometry. Furthermore, a coupler point 18, which is designed as a head-shaped elevation in the exemplary embodiment of damping element 12 shown in FIG. 1, is situated in base surface 14 of damping element 12. Multiple aperture cross sections 24 are provided in base surface 14 of damping element 12. These may be provided in base surface 14 within an eccentric aperture arrangement (measurement a in FIG. 1) corresponding to the aperture function to be set which is inherent in damping element 12 according to the present invention. A bead 20, which passes into a spring receptacle 22, is situated above lateral surface 16 of damping element 12. Spring receptacle 22 is situated as a generally annular shoulder on one open end 32 (see representation shown in FIG. 2) of damping element 12 according to the present invention. The annular surface of spring receptacle 22 may be designed having a larger or smaller diameter corresponding to an inserted spring element.

A section through the damping element according to FIG. 1 according to section II-II is shown in the representation in FIG. 2.

As shown in FIG. 2, damping element 12 is designed symmetrically to symmetry axis 10 and has an annular surface forming a spring receptacle 22 at its open end 32. The generally cup-shaped damping element 12 may be manufactured by a punching or bending process or by deep drawing. Damping element 12 has a generally constant material thickness. Situated in base surface 14 and lateral surface 16 on both sides of head-shaped coupler point 18 are aperture cross sections 24 which are provided in an eccentric aperture arrangement 30 (see measurement a in FIG. 1) into base surface 14 of damping element 12. Instead of coupler point 18 represented in FIG. 2 as a head-shaped elevation, base surface 14 may also have a plane configuration. The thickness of base surface 14 is indicated by reference numeral 28, the axial length of damping element 12 according to the present invention being indicated by reference numeral 26.

Damping element 12 according to the present invention may be manufactured as a punched part or as a bent part. A material which is not magnetizable or difficult to magnetize is preferably selected so that magnetic isolation by damping element 12 may be achieved. This is described below in greater detail.

Damping element 12 shown in FIGS. 1 and 2 has, in addition to its functionality of damping adjustment, the functionality of a spring receptacle since a spring element, which is not shown in FIGS. 1 and 2, may rest on annular spring receptacle 22 at open end 32 of damping element 12. Furthermore, the functionality of coupler point 18, given by the head-shaped elevation in base surface 14 of damping element 12, is integrated into damping element 12 according to the present invention. In addition, damping element 12 according to the present invention and according to the representations in FIGS. 1 and 2 makes magnetic isolation possible between an armature and an actuator to be actuated by the armature. Damping element 12 according to the present invention is preferably manufactured as a separate individual component.

Due to the small base thickness 28 of base surface 14 of damping element 12 it is possible to achieve a good aperture function using damping element 12 according to the present invention designed as a separate component since a small length to diameter ratio is established due to the smaller base thickness 28 of base surface 14 proportional to the diameter of aperture cross section 24. Moreover, small aperture diameters may be achieved and eccentric bore hole geometries 30 in base surface 14 may be implemented in a rather simple manner.

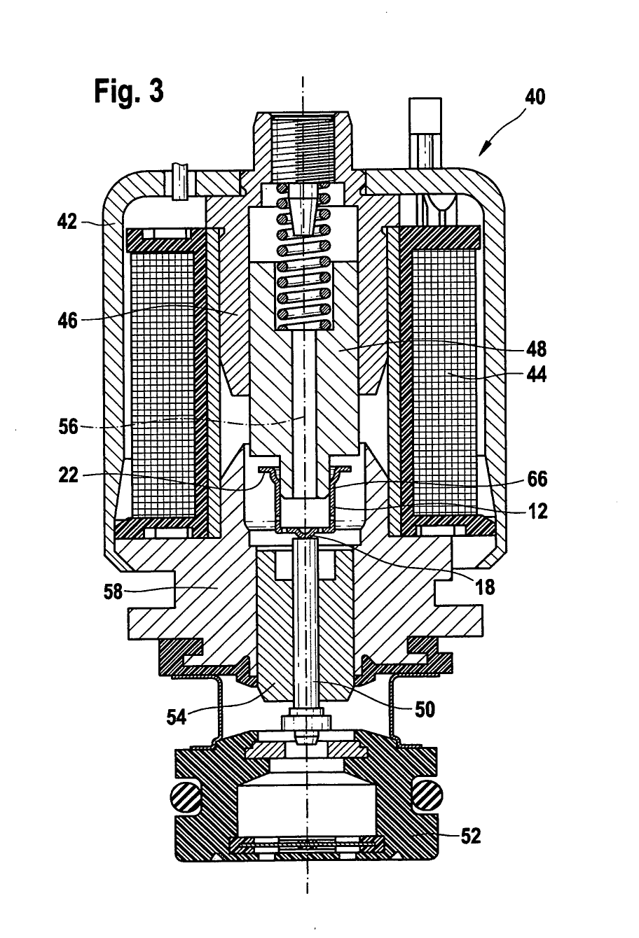

A solenoid valve having a damping element attached to an armature is shown in FIG. 3.

A solenoid valve 40 includes a housing 42 which accommodates an electromagnet 44. In addition, an armature guide 46 which encloses an armature 48 is situated in housing 42 of solenoid valve 40. On the front face facing a valve needle 50, damping element 12 according to the present invention is attached to a seat 66 on armature 48. The armature is fastened on seat 66 of damping element 12 on armature 48 in a force-fit or form-locked manner or by an integral joint.

An integral joint may be established by welding, whereas a form-locked joint may be formed by caulking; a press fit between armature 48 and damping element 12 represents a force-fit connection option between armature 48 and damping element 12.

The installed position of damping element 12 on the front face of armature 48 facing valve needle 50 creates a hollow space between the front face of armature 48 and base surface 14 of damping element 12 formed by lateral surface 16 of damping element 12. Coupler point 18 formed in base surface 14 of damping element 12 contacts the front face of valve needle 50 which itself is guided in a valve needle bearing 54. For example, a flat seat 52 or the like may be actuated via valve needle 50.

Due to the installed position of damping element 12 according to FIG. 3, magnetic isolation between valve needle 50 for actuating flat seat 52 and armature 48 of solenoid valve 40 is established. Furthermore, coupler point 18, formed as a head-shaped elevation in base surface 14 of damping element 12, may be implemented very cost-effectively.

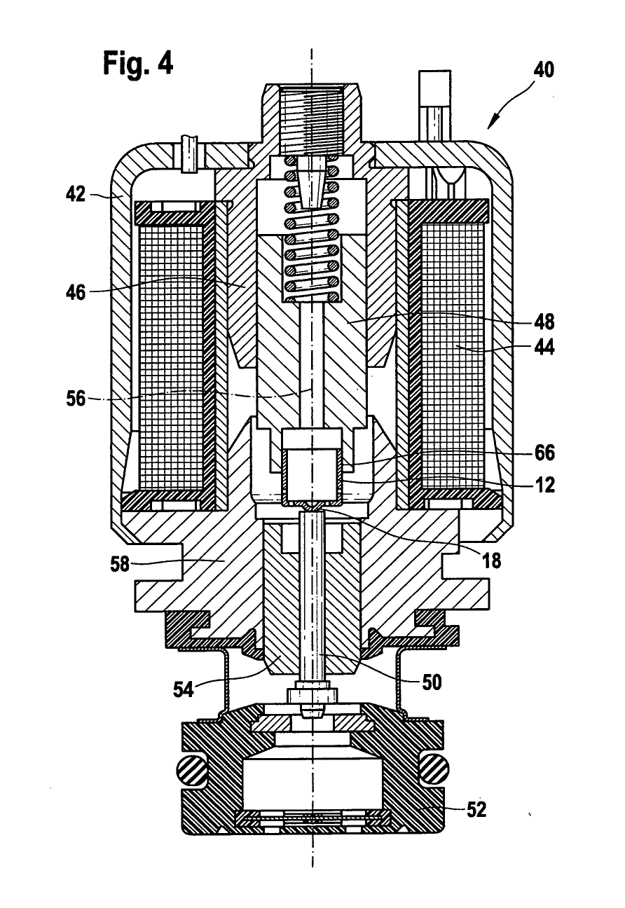

FIG. 4 shows a damping element pressed into an armature of a solenoid valve.

As shown in FIG. 4, armature 48 of solenoid valve 40 has a bore hole at its end facing valve needle 50 which has a greater diameter compared to the embodiment shown in FIG. 3. Damping element 12 is pressed into this bore hole on armature 48. In this embodiment, damping element 12 is compared to the representations in FIGS. 1 and 2, designed without bead 20 and without spring receptacle 22 also shown in FIGS. 1 and 2.

In the exemplary embodiment in FIG. 4, seat 66 of damping element 12 is situated inside of armature 48 and not, as shown in FIG. 3, on the outer circumference of armature 48.

In this exemplary embodiment, seat 66 may also be produced via a force-locked joint, such as a press fit for example, via a form-locked joint, such as caulking for example, or via an integrated joint, such as a welding connection for example.

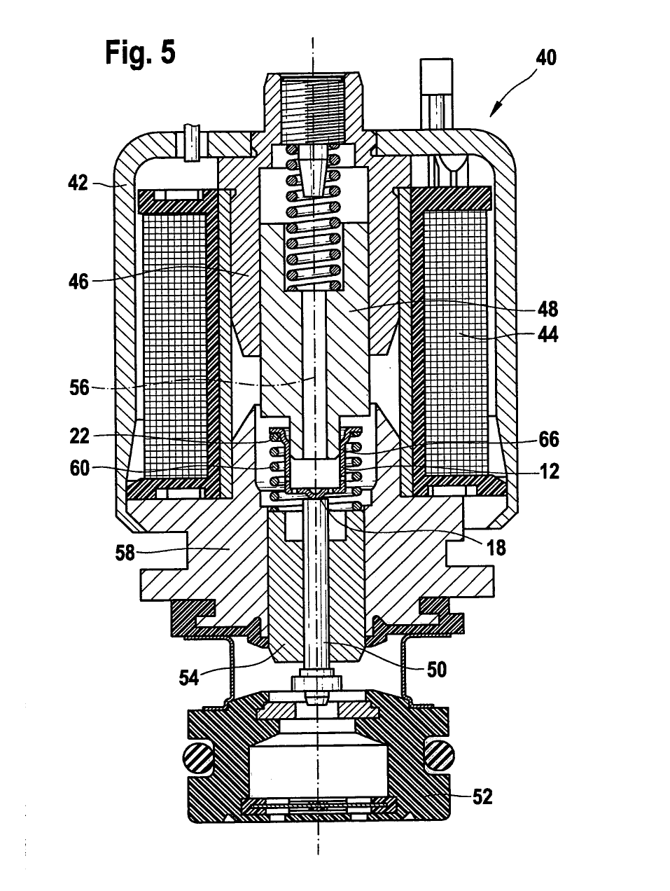

A solenoid valve is shown in FIG. 5 on whose armature damping element 12 according to the present invention is mounted, a spring element resting on the damping element.

It is apparent from the representation in FIG. 5 that a spring element 60 rests on the annular spring receptacle 22 on damping element 12. Depending on the coil diameter of spring element 60, annular spring receptacle 22 at open end 32 of damping element 12 may be designed having a greater or smaller diameter so that a secure fit of spring element 60 on the underside of spring receptacle 22 on damping element 12 is ensured. The opposite end of spring element 60 may rest on the front face of valve needle bearing 54, as shown in FIG. 5. It is alternatively also possible that the other end of spring element 60 opposite spring receptacle 22 rests on bearing receptacle 58 in the lower part of solenoid valve 40.

Damping element 12 shown in FIG. 5 is also joined to a seat 66 on armature 48. Joining damping element 12 to armature 48 may be carried out by way of an integral joining method, such as welding, for example; in addition, damping element 12 according to the present invention may be pressed with its open end 32 onto the front face of armature 48 or may be caulked to armature 48.

Solenoid valve 40 shown in FIG. 5 generally corresponds to solenoid valve 40 shown in FIG. 3 and similarly includes housing 42, electromagnet 44, armature guide 46, as well as armature 48. A flat seat 52 is actuated via valve needle 50 which is guided in valve needle bearing 54. Instead of flat seats 52 shown in FIGS. 3 and 5, another actuator, e.g., for a pressure control valve, may be actuated via valve needle 50 using electromagnet 44.

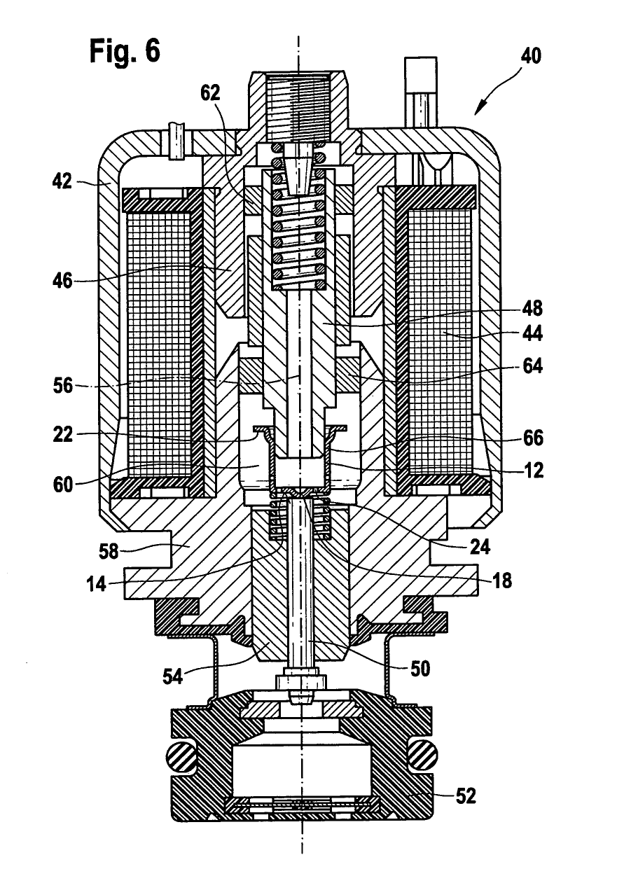

A further exemplary embodiment of a solenoid valve is shown in FIG. 6 on whose armature damping element 12 according to the present invention is mounted.

As a variant of solenoid valves 40 shown in FIGS. 3 and 5, armature 48 according to the exemplary embodiments of solenoid valve 40 in FIG. 6 has a multi-part design and is enclosed by a sleeve between a first bearing ring 62 and a second bearing ring 64. On the front face of armature 48 facing valve needle 50, cup-shaped damping element 12 is accommodated on seat 66. Seat 66 may be produced via a press fit, via an integral joint, or via caulking. In the exemplary embodiment of solenoid valve 40 according to FIG. 6, coupler point 18 formed in base surface 14 of damping element 12 is a head-shaped elevation which is in contact with the upper front face of valve needle 50. A flat seat 52, as the actuator to be actuated, is designed on valve needle 50. Valve needle bearing 54 is accommodated in a bore hole of bearing receptacle 58 which is enclosed by housing 42 of solenoid valve 40. Armature 48 is supported with the aid of first bearing ring 62 and second bearing 64 in armature guide 46 on the one hand and in bearing receptacle 58 on the other hand.

The representations of solenoid valves 40 according to FIGS. 3 through 6 show that, by using damping element 12 according to the present invention which is preferably made of a material which is not magnetizable or difficult to magnetize, magnetic isolation between armature 48 and valve needle 50, on the one hand, and magnetic isolation (see representation in FIG. 5) between spring element 60 and armature 48 may be implemented in a cost-effective manner. Among other things, damping element 12 according to the present invention is characterized in that the functionalities of spring receptacle 22, damping adjustment, coupler point 18 to valve needle 50 and the magnetic isolation are combined in a single component. Furthermore, a good aperture function is inherent in damping element 12 according to the present invention since the small material thickness of base surface 14 creates a favorable length to diameter ratio on damping element 12 and an eccentric aperture arrangement 30 is very easily implemented from the manufacturing point of view also for small diameters of aperture cross sections 24.

1-13. (canceled)

14. A solenoid valve for actuating an actuator, comprising;
a housing;
an armature movably accommodated in a guide of the housing;
an electromagnet;
a transfer element;
a stroke of the armature being transferred to the actuator via the transfer element and the armature; and
a damping element situated between the armature and the transfer element, at least one aperture cross section being formed one of perpendicularly or coaxially to its symmetry axis in the damping element.

15. The solenoid valve as recited in claim 14, wherein a space in the housing which encloses the armature is filled with a fluid.

16. The solenoid valve as recited in claim 14, wherein the damping element is cup-shaped, having a base surface and a lateral surface which have a same material thickness.

17. The solenoid valve as recited in claim 16, wherein the base surface includes at least one aperture cross section or a number of aperture cross sections which are situated in the base surface eccentrically to the symmetry axis of the damping element.

18. The solenoid valve as recited in claim 16, wherein the lateral surface of the damping element includes at least one aperture cross section or a number of aperture cross sections.

19. The solenoid valve as recited in claim 16, wherein a ratio of a material thickness of the base surface to a mean diameter of the aperture cross section or the aperture cross sections is less than 1.

20. The solenoid value as recited in claim 19, wherein the ratio is 0.5.

21. The solenoid valve as recited in claim 14, wherein the damping element is made of a material which is one of: i) not magnetizable, or ii) difficult to magnetize.

22. The solenoid valve as recited in claim 16, wherein a coupler point is formed in the base surface of the damping element.

23. The solenoid valve as recited in claim 22, wherein the coupler point has one of a dome-shaped elevation, or a plane surface.

24. The solenoid valve as recited in claim 14, further comprising:
a spring receptacle as a ring surface at an open end of the damping element.

25. The solenoid valve as recited in claim 14, further comprising:
a spring element positioned against the base surface of the damping element.

26. The solenoid valve as recited in claim 14, wherein the damping element is fastened to the armature or the transfer element on a seat in a force-locking or form-locking or in an integrally joined manner.

27. The solenoid valve as recited in claim 14, wherein the damping element magnetically isolates the armature from the transfer element or the armature from a spring element.
